(19) United States
(12) Patent Application Publication
(10) Pub. No.: US 2026/0333023 A1
(43) Pub. Date: Oct. 22, 2026

(54) SECURE RETRIEVAL OF UPDATED PARAMETERS

(71) Applicant: Cisco Technology, Inc., San Jose, CA (US)

(72) Inventors: Binita Gupta, San Diego, CA (US); Brian D. Hart, Sunnyvale, CA (US); Anuj Dharap, Copley, OH (US); Stephen M. Orr, Wallkill, NY (US)

(21) Appl. No.: 19/652,430

(22) Filed: Apr. 20, 2026

Related U.S. Application Data
(60) Provisional application No. 63/791,163, filed on Apr. 18, 2025.
(60) Provisional application No. 63/981,184, filed on Feb. 12, 2026.
(60) Provisional application No. 64/007,243, filed on Mar. 16, 2026.

(51) Int. Cl. H04W 8/24; H04L 9/32

(52) U.S. Cl. CPC H04W 8/24; H04L 9/32

(57) ABSTRACT

Secure retrieval of updated parameters by a client device from its associated access point and, particularly, protection of request frames and response frames for communicating parameter updates may be provided. An access point (AP) receives a request frame from a station (STA) requesting Ultra High Reliability (UHR) operating parameters for one or more links of the AP. The AP generates a response frame comprising the UHR operating parameters for the one or more links of the AP, wherein generating the response frame comprises applying integrity protection to the response frame. The AP transmits the response frame to the STA.

### RELATED APPLICATIONS

Under provisions of 35 U.S.C. § 119(e), Applicant claims the benefit of and priority to U.S. Provisional Application No. 63/791,163, filed Apr. 18, 2025, U.S. Provisional Application No. 63/981,184, filed Feb. 12, 2026, and U.S. Provisional Application No. 64/007,243, filed Mar. 16, 2026, the disclosures of which are incorporated herein by reference in their entirety.

### TECHNICAL FIELD

The present disclosure relates generally to secure retrieval of updated parameters by a client device from its associated access point, and particularly to providing protection of request frames and response frames for communicating parameter updates.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing secure retrieval of updated parameters by protection of request frames and response frames for communicating parameter updates in accordance with aspects of the present disclosure.

FIG. 2 is a block diagram of an example Probe Response frame in accordance with aspects of the present disclosure.

FIG. 3 is a block diagram of an example Ultra High Reliability (UHR) Link Reconfiguration Request frame in accordance with aspects of the present disclosure.

FIG. 4 is a block diagram of an example UHR Link Reconfiguration Response frame in accordance with aspects of the present disclosure.

FIG. 5 illustrates a signaling flow for exchanging protected request and response frames in accordance with aspects of the present disclosure.

FIG. 6 is a flow diagram illustrating a method for protection of request frames and response frames for communicating parameter updates in accordance with aspects of the present disclosure.

FIG. 7 is a block diagram of a computing device in accordance with aspects of the present disclosure.

FIG. 8 is a block diagram of a communications device in accordance with aspects of the present disclosure.

### DETAILED DESCRIPTION

### Overview

Secure retrieval of updated parameters by a client device from its associated access point and, particularly, protection of request frames and response frames for communicating parameter updates may be provided. An access point (AP) receives a request frame from a station (STA) requesting Ultra High Reliability (UHR) operating parameters for one or more links of the AP. The AP generates a response frame comprising the UHR operating parameters for the one or more links of the AP, wherein generating the response frame comprises applying integrity protection to the response frame. The AP transmits the response frame to the STA.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

For many Ultra High Reliability (UHR) operations, Access Points (APs) need to provide advance notification to Stations (STAs) (e.g., non-AP Multi-Link Devices (MLDs)) before making critical updates to basic service set (BSS) parameters or MLD parameters effective. This advance notification that provides the updated parameters helps STAs better prepare for the configuration changes caused by those updates. The notification providing the updated parameters should also persist for a sufficient duration before (and, optionally, after) the critical updates become effective so that most STAs can receive the updates (e.g., updated BSS and/or MLD parameters) even when they intermittently sleep, ignore some frames, or are otherwise temporarily unavailable. This process for UHR critical updates extends the advance notification mechanism defined for Extremely High Throughput (EHT) (Wi-Fi 7), which provided advance notification for AP removal using a Reconfiguration element and for AP link enable/disable using a Traffic Identifier (TID)-to-Link Mapping element. In UHR, a broader range of operating modes are subject to critical updates, requiring a more general and flexible critical update notification and parameter signaling framework.

Example operations that require advance notification include enabling or disabling operating modes, or updating associated operating mode parameters, for operating modes including Dynamic Power Save (DPS), Dynamic Unavailability Operation (DUO), Periodic Unavailability Operation (PUO), AP Periodic Power Save (AP PPS), AP PUO, Non-Primary Channel Access (NPCA), Dynamic Subband Operation (DSO), Dynamic Bandwidth Expansion (DBE), and Prioritized Enhanced Distributed Channel Access (P-EDCA), among others. Critical updates may further include UHR per-link level parameter updates, UHR per-MLD level parameter updates (e.g., updates to MLD-level capability), and updates to the AP's Basic UHR Modulation and Coding Scheme (MCS) and Number of Spatial Streams (NSS) Set.

APs can provide critical updates in management frames such as Beacon frames, Probe Response frames, UHR Link Reconfiguration Response frames (or EHT defined Link Reconfiguration Response frames), UHR Link Reconfiguration Notify frames (or EHT defined Link Reconfiguration Notify frames), and (Re)Association Response frames. The occurrence of a critical update is signaled using a UHR Critical Update Flag (CUF) and a UHR BSS Parameters Change Count (BPCC). The UHR CUF is set to a value (e.g., 1) and the UHR BPCC is incremented when a critical update is initiated. Critical updates to operation modes and associated operating parameters are reported in a Critical Parameters Update (CPU) element in these frames. Inclusion of a Critical Parameters Update (CPU) element in a Beacon or Probe Response frame is treated as a critical update, and modification of the CPU element similarly constitutes a critical update triggering setting the CUF and updating the UHR BPCC. When the critical update actually takes effect at the time indicated in the CPU element (e.g. at a Target Beacon Transmission Time (TBTT) at which critical update takes effect), the UHR BPCC is not incremented again, as the UHR BPCC counter was already incremented when the CPU element was first added or modified.

The CPU element carries information associated with the critical updates and is included in management frames in advance of the updates becoming effective. After the critical update becomes effective, the same CPU element may continue to be carried in Beacon frames using a special value in the Critical Update Switch Time field (e.g., a value of zero or another value) to indicate that the update has already taken effect. In some embodiments, an AP may simultaneously include two CPU elements. One CPU element provides advance notification for an upcoming critical update (with the switch time field indicating a future effective time) and another CPU element provides updated parameters for a critical update that has already become effective (with a specific switch time value indicating this). In some embodiments, the duration for signaling critical updates, both before and after the effective time, is based on the listen intervals provided by STAs during association with the AP.

In addition to the CPU element, the UHR Operation element may be defined to carry UHR operating mode parameters. In steady-state Beacon frames (e.g., when no critical update is pending or has become recently effective), the UHR Operation element indicates only which operating modes are enabled or disabled, without carrying detailed operating parameters, in order to avoid beacon bloating. In Probe Response and (Re)Association Response frames, however, the UHR Operation element carries operating parameters for the enabled UHR operating modes, ensuring that STAs can obtain full operating mode parameters during association or individual probe exchange. When all updated parameters associated with a given critical update are present in the management frames, a UHR All Updates Included flag is set to indicate to receiving STAs that no further individual parameter fetching is necessary, since all the updated parameters are included in the current frame itself.

Once critical updates become effective, some STAs, such as those that were in deep sleep during the notification period before and/or after the critical updates become effective, may wake up with no knowledge of the updated parameters. These STAs will determine that some critical updates have occurred to BSS or MLD level parameters based on the updates counter values received in beacon frames such as an updated UHR BPCC value or an updated critical update counter value in the Traffic Indication Map (TIM) element and will initiate individual Probe Request/Response exchanges with their associated AP MLD to retrieve the updated parameters. This Probe Request/Response exchange occurs post-association and is distinct from the Probe Request/Response exchange performed for the purpose of scanning and discovering an AP or AP MLD prior to association. Probe Response frames, however, are not integrity protected (e.g., Message Integrity Check (MIC) protected) by default, unlike Beacon frames. If a malicious entity tampers with or modifies UHR operation parameters carried in an unprotected Probe Response frame, this can adversely impact BSS operation, expose the network to Denial of Service (DoS) attacks, and lead to other unwanted outcomes.

Once critical updates become effective, STAs that were in deep sleep throughout the (advance and post) notification period may wake up with no knowledge of the updated parameters and will initiate post-association Probe Request/Response exchanges with their associated AP MLD to retrieve them. Because Probe Response frames are not integrity protected by default, a malicious entity could tamper with the UHR operation parameters they carry, adversely impacting BSS operation and exposing the network to Denial of Service (DoS) attacks and other unwanted outcomes. The embodiments described herein address this vulnerability by defining mechanisms for protecting Probe Request and Probe Response frames, and alternative protected frame types serving the same purpose, to enable UHR STAs to securely retrieve the latest UHR operating parameters from their associated AP MLD after a critical update occurs on any link of the AP MLD.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

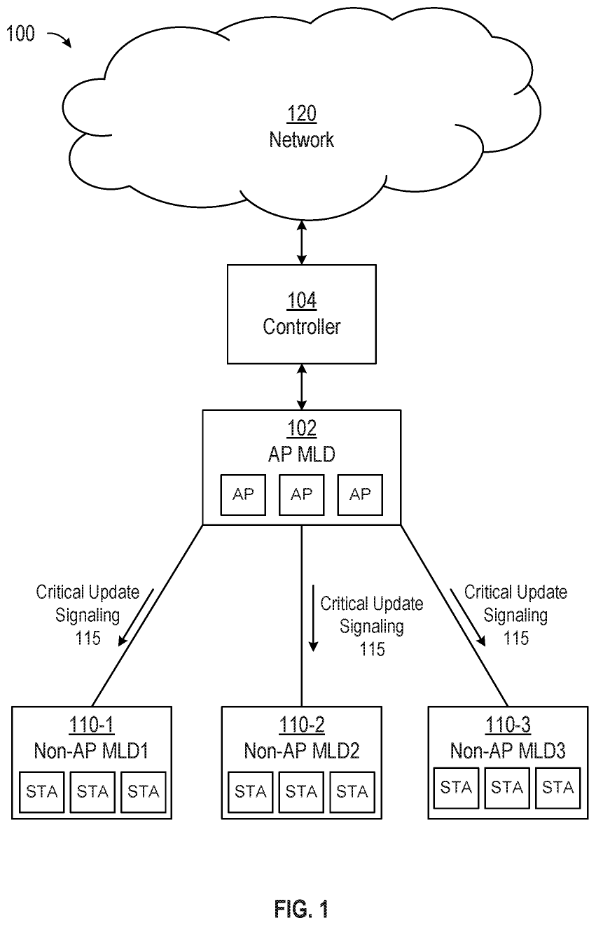

FIG. 1 is a block diagram of an operating environment 100 for providing secure retrieval of updated parameters using protection of request frames and response frames for communicating parameter updates. The operating environment 100 includes an AP MLD 102, a controller 104, non-AP MLDs 110 (illustrated as non-AP MLD1 110-1, non-AP MLD2 110-2, and non-AP MLD3 110-3), and a network 120.

The AP MLD 102 is configured to communicate with and/or enable devices such as the non-AP MLDs 110 to wirelessly connect to the network 120. The controller 104 is a network controller, such as a Wireless Local Area Network (WLAN) controller, configured to manage and control the AP MLD 102, the non-AP MLDs 110, and/or other network devices. The AP MLD 102 and/or the controller 104 can include router components or connect to an external router for routing traffic and otherwise managing WLAN operation. In certain embodiments, the AP MLD 102 acts as a controller and the controller 104 is not present in the operating environment 100; for example, the AP MLD 102 can include components to act as a WLAN controller.

The non-AP MLDs 110 are any client device (i.e., STA), such as a smartphone, tablet, laptop, personal computer, or internet-of-things device. Different non-AP MLDs 110 may have different capabilities and operational characteristics, including different listen intervals, different beacon processing capabilities, and different power-saving behaviors that periodically affect their availability for receiving frames.

As shown in FIG. 1, the non-AP MLDs 110 and the AP MLD 102 are each MLDs that include one or more affiliated STAs (referred to as APs with respect to the AP MLD 102). The non-AP MLDs 110 use their affiliated STAs to form links with the affiliated APs of the AP MLD 102. Each affiliated STA/AP may include Physical (PHY)-layer and lower-Media Access Control (MAC) components. The MLDs may also include an upper-MAC for coordinating the multiple affiliated STAs/APs (or links) that are part of the MLD. The affiliated STAs/APs can operate across different frequency bands, including 2.4 GHz, 5 GHz, 6 GHz, or other bands.

The network 120 is a set of devices that facilitate communication between senders and destinations, such as by implementing communication protocols. Example networks 120 include local area networks, wide area networks, intranets, or the Internet. In certain embodiments, the network 120 includes one or more systems for managing or otherwise controlling critical update signaling operations.

In operation, the AP MLD 102 implements critical update signaling 115 mechanisms to ensure that all associated non-AP MLDs 110 can reliably detect and receive critical network configuration changes. When a critical update occurs, the AP MLD 102 signals the update in advance (and, optionally, after the update becomes effective) by including a CPU element in management frames such as Beacon frames, Probe Response frames, and (Re)Association Response frames. Adding or modifying the CPU element constitutes a critical update, causing the AP MLD 102 to set the UHR CUF (e.g., to 1) and increment the UHR BPCC for the affected link. The CPU element indicates the operating modes being updated, the time at which the critical update will take effect (e.g. the TBTT at which the update takes effect), and updated parameters for the affected operating modes. Non-AP MLDs 110 that are awake during the advance notification period or post update notification period receive these parameters directly from Beacon frames. Non-AP MLDs 110 that miss the notification period (e.g., both advance and post update implementation), such as because they were in deep sleep throughout, can detect a changed UHR BPCC upon waking and initiate a post-association Probe Request/Response exchange with the AP MLD 102 to acquire the updated parameters individually.

After a critical update becomes effective, the AP MLD 102 may continue to carry the CPU element using a special value in the Critical Update Switch Time field to indicate that the update has already taken effect, and/or uses a UHR Operation element to advertise the current critical update status for a period sufficient to reach non-AP MLDs 110 that were in deep sleep during the advance notification period. When all updated parameters associated with a critical update are included in the advertised management frames, a UHR All Updates Included flag is set (e.g., to 1) to inform non-AP MLDs 110 that no further individual parameter fetching is necessary.

Because the AP MLD 102 operates across multiple links, critical updates for a given link are signaled per-link, with the UHR CUF and UHR BPCC incremented for the affected link. Non-AP MLDs 110 monitoring other links of the AP MLD 102 are informed of the update through a Reduced Neighbor Report (RNR) element carrying the updated UHR BPCC for the affected link and, in some embodiments, through a Basic multi-link (ML) element that includes the CPU element in the Per-STA Profile corresponding to the affected link.

The embodiments described herein address the security vulnerability arising from the use of unprotected Probe Response frames in the post-association critical update parameter retrieval context. The invention defines mechanisms for protecting Probe Request and Probe Response frames exchanged post-association between a non-AP MLD 110 and the AP MLD 102. In a primary embodiment, a non-AP MLD 110 sends a Protected Management Frames (PMF)-protected Probe Request frame (non-ML or ML) to fetch the updated parameters. In some embodiments, the non-AP MLD 110 may send an unprotected Probe Request frame as defined in current 802.11 baseline to fetch the updated parameters. The AP MLD 102 responds with either an individually addressed PMF-protected Probe Response frame (encrypted with a Pairwise Transient Key (PTK)) or a broadcast addressed Probe Response frame that is integrity-protected using the Broadcast/multicast Integrity Protocol (BIP), with a Management MIC Element (MME) (also referred to as a Management MIC Information Element (MMIE) in some implementations) appended as the last element before the Frame Check Sequence (FCS). The MIC may be generated using an existing key (e.g., the Beacon Integrity Group Temporal Key (BIGTK) or the Integrity Group Temporal Key (IGTK), a dedicated Probe Response Integrity Group Temporal Key (PIGTK), or a key derived from a BSS Privacy Enhancement (BPE) Identity Key. In embodiments where frames are not encrypted, both the Probe Request and Probe Response may be integrity-protected by a MIC by adding an MME (containing MIC) as the last element in the frame, before the FCS, without encrypting the frame. If the Probe Request is PMF protected, then the corresponding probe response is also PMF protected. If the probe request is unprotected or integrity protected (by providing a MIC in the MME) then the probe response may be integrity protected (by providing a MIC in the MME).

Non-AP MLDs 110 that did not originate a Probe Request can passively receive and verify broadcast addressed Probe Response frames, reducing the total number of unicast exchanges in the BSS. AP and STA support for these mechanisms is coordinated through a capability field in the UHR Capabilities element, Extended Capabilities element, Robust Security Network Extension Element (RSNXE) element, or another element, and must be consistently indicated across all affiliated APs of the AP MLD 102 and, within a seamless mobility domain (SMD), across all AP MLDs of the SMD. Where protecting standard Probe Response frames is not feasible, alternative protected frame types serve the same purpose. The alternative protected frame types may include new frames defined for this purpose such as BSS Capabilities and Operation Parameters Request/Response action frames, IEEE 802.11bi defined Enhanced Privacy Protection (EPP) Capabilities and Operation Parameters Request/Response frames also carrying UHR-defined elements, and UHR Link Reconfiguration Request/Response or UHR Link Reconfiguration Notify frames with a new Type value. In all cases, response frames carry a Basic ML element (or a Reconfiguration ML element) with Per-STA Profile subelements providing the latest UHR-specific BSS parameters (and MLD level parameters) for all or a requested subset of the AP MLD's links. The AP MLD 102 may also transmit response frames unsolicited (individually addressed or broadcast addressed) to proactively push updated parameters to associated non-AP MLDs 110 without waiting for a client request.

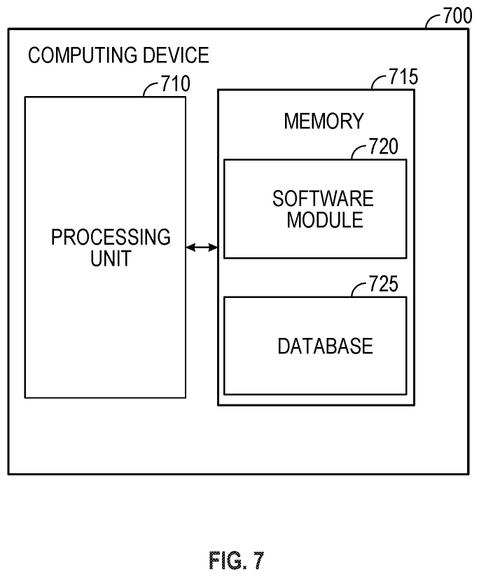

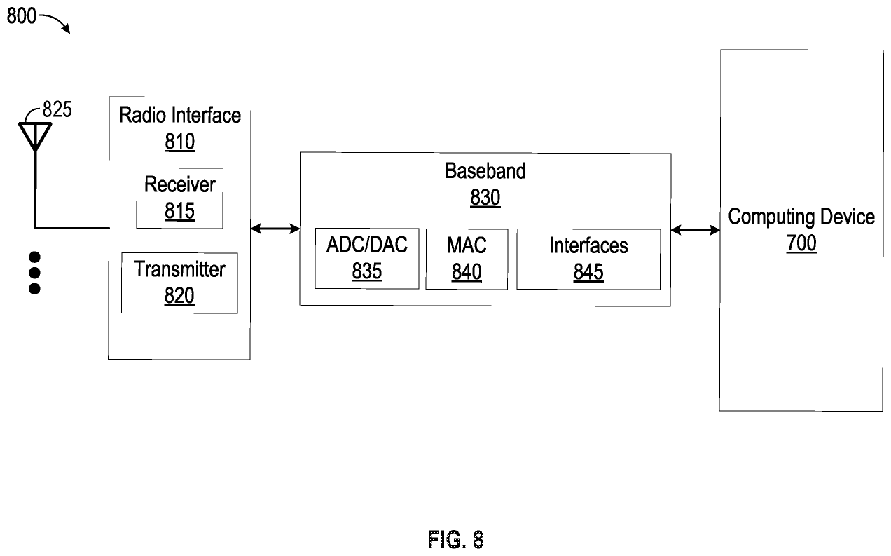

The elements described above of the operating environment 100 (e.g., the AP MLD 102, the controller 104, the non-AP MLDs 110, the devices of the network 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 7 and 8, the elements of the operating environment 100 may be practiced in a computing device 700 and/or communications device 800.

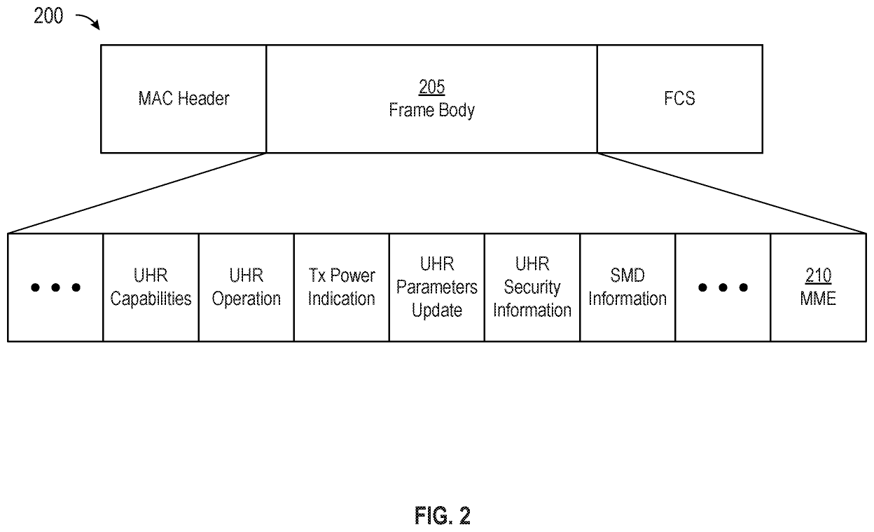

FIG. 2 illustrates an example Probe Response frame 200. APs can transmit the Probe Response frame 200, broadcast addressed or individually addressed, to provide updated UHR operating parameters to STAs. The frame body 205 carries UHR-specific elements including, for example, a UHR Operation element and a UHR Parameters Update element providing the latest BSS and MLD-level operating parameters, as well as a Basic ML element with Per-STA Profile subelements carrying UHR-specific parameters for one or more links of the AP MLD (e.g., by including a UHR Operation element, a UHR Parameters Update element, or other UHR elements in STA Profile field). An MME 210 is appended as the final element of the frame body 205, immediately preceding the FCS.

The MME 210, also referred to as an MMIE in some implementations, carries a MIC generated over the frame body using the BIP and the group management cipher advertised in the Robust Security Network Element (RSNE) or another element (e.g., a UHR Security Information element). Appending the MME 210 as the last element before the FCS ensures that any modification to the frame body or the elements preceding the MME 210 will cause MIC verification to fail at the receiver, preventing tampering with the UHR operation parameters carried in the frame.

APs can use several keying options for generating the MIC carried in the MME 210. In one embodiment, the existing BIGTK, defined for integrity protecting of beacon frames, is reused for integrity protection of broadcast addressed Probe Response frames, simplifying key management by avoiding the need to distribute and manage a new key. In a second embodiment, the existing IGTK, defined for integrity protecting group addressed management frames, is used to generate the MIC. In a third embodiment, a new dedicated PIGTK is defined specifically for this purpose, providing cryptographic separation between beacon integrity protection and broadcast Probe Response integrity protection. A separate PIGTK is generated by the AP MLD as part of the process of generating other existing group keys such as BIGTK, IGTK etc. and is distributed to the associated clients as part of group keys distribution mechanism defined as used for other group keys. The PIGTK is rekeyed and distributed to STAs using standard group key handshake mechanisms, e.g. it is delivered securely as part of a 4-way handshake (in Message 3), a group key handshake, or another mechanism used to deliver group keys securely to non-AP MLDs. In a fourth embodiment, a BPE Identity Key, as defined in IEEE 802.11bi, is used. Because the BPE Identity Key is used for encrypting Beacon frames rather than integrity protecting them, a BPE AP MLD may instead generate a distinct BPE Integrity Key (BPE-IGTK) derived from the BPE Identity Key, which is then used for generating the MIC for broadcast addressed Probe Response frames.

When the Probe Response frame 200 is individually addressed, it is PMF-protected (i.e., encrypted) using the pairwise key established between the STA and the AP MLD in some embodiments. In other embodiments, an individually addressed Probe Response frame 200 may be integrity protected without encryption. In these embodiments, the MIC is generated using the Pairwise Transient Key (PTK) or another key established for this purpose and appended as the last element before the FCS as described above (i.e., in the MME 210).

When the Probe Response frame 200 is broadcast addressed, it may be integrity protected using BIP with the MME 210 as described above, or it may alternatively be encrypted using the IGTK or another group key derived for this purpose. In a further embodiment, broadcast addressed Probe Response frames are unconditionally MIC-protected regardless of whether a corresponding protected Probe Request was received. For example, the AP always appends an MME 210 when transmitting a broadcast addressed Probe Response frame, similar to the manner in which Beacon frames are always MIC-protected using the BIGTK. In this embodiment, any STA that has associated with the AP MLD and received the applicable group keys can verify the MIC upon receiving any broadcast addressed Probe Response frame, including both non-AP MLDs that originated a Probe Request and non-AP MLDs that are passively listening on the channel without having sent a Probe Request. The MIC contained in the MME for the broadcast addressed Probe Response may be generated using the BIGTK, the IGTK or the PIGTK as described above.

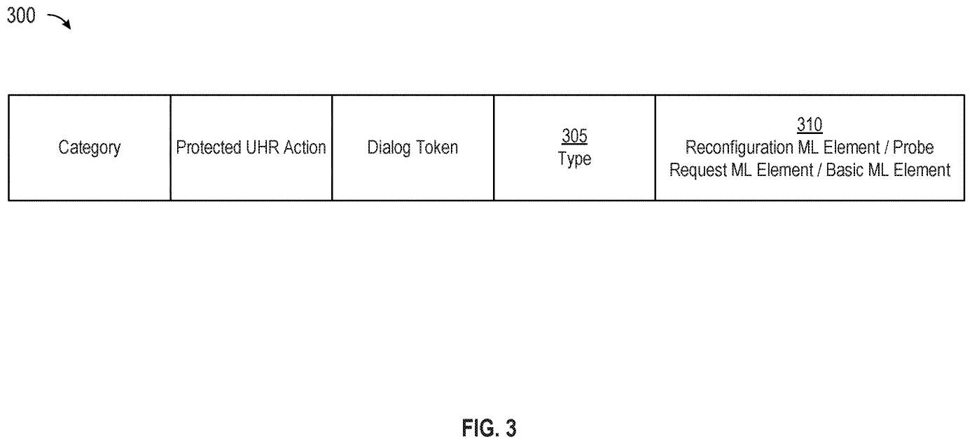

FIG. 3 illustrates an example UHR Link Reconfiguration Request frame 300. The UHR Link Reconfiguration Request frame 300 includes a Category field, a Protected UHR Action field, a Dialog Token field, a Type field 305, and a field 310.

The Type field 305 is set to a new Type value indicating a request to fetch BSS capabilities and operation parameters from the current AP MLD. This new Type value distinguishes this use of the UHR Link Reconfiguration Request frame 300 from uses of the frame having previously defined Type values.

The field 310 carries a ML element identifying the links for which parameters are being requested. The ML element can be a Reconfiguration ML element, a Probe Request ML element, or a Basic ML element, in all cases including Per-STA Profile subelements identifying the requested links. A non-AP MLD may include Per-STA Profile subelements only for the links on which it has detected a critical update (e.g., based on a changed Critical Update Counter value or UHR BPCC for those links), thereby limiting the request to the subset of links for which updated parameters are needed. If no specific links are indicated in the ML element included in the field 310, the request is interpreted as requesting the latest BSS parameters for all setup links with the AP MLD. To further limit the scope of the response, the non-AP MLD may include a Request element and/or an Extended Request element within the Per-STA Profile subelements of the ML element in the field 310, specifying the particular elements (e.g., a UHR Parameters Update element or a UHR Operation element) being requested for each link, rather than all available BSS parameters. This allows a STA to request only UHR-specific parameters when it knows that only UHR parameters have changed, reducing the size of the resulting response frame. The UHR Link Reconfiguration Request frame 300 is transmitted PMF protected in example implementations.

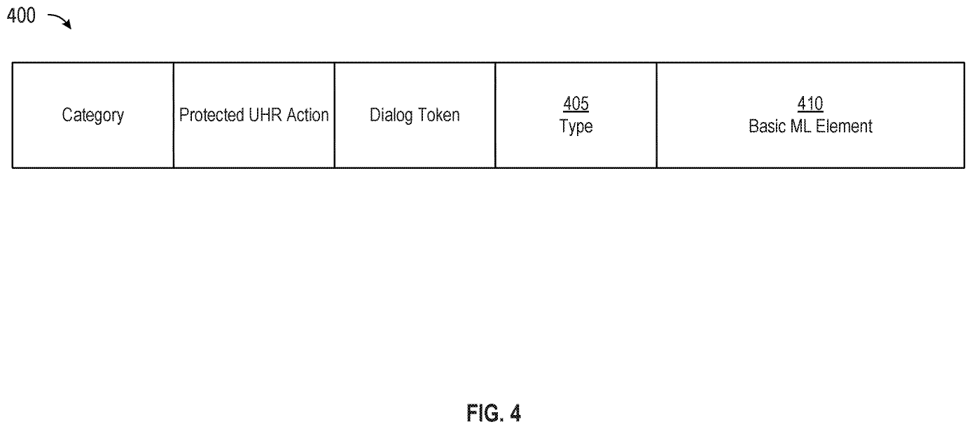

FIG. 4 illustrates an example UHR Link Reconfiguration Response frame 400. The UHR Link Reconfiguration Response frame 400 includes a Category field, a Protected UHR Action field, a Dialog Token field, a Type field 405, a Basic ML element 410, and an optional Status Code (not shown).

The Type field 405 is set to a new Type value (e.g., the same value as the corresponding UHR Link Reconfiguration Request frame 300), indicating that the frame carries BSS capabilities and operation parameters.

The Basic ML element 410 carries the latest BSS parameters in Per-STA Profile subelements for the requested affiliated APs or, where no specific links were requested, for all links that are setup for the requesting non-AP MLD. The Per-STA Profile subelements include all UHR-specific BSS parameters carried in UHR-defined elements, including UHR Capabilities, UHR Operation, SMD Information, and UHR Parameters Update elements, among others. The UHR Link Reconfiguration Response frame 400 is transmitted PMF protected.

In another embodiment, a UHR Link Reconfiguration Notify frame may be used in place of the UHR Link Reconfiguration Request and Response frames. In this embodiment, a new Type value is defined for the UHR Link Reconfiguration Notify frame, and the non-AP MLD sends a UHR Link Reconfiguration Notify frame with this new Type value and with the same parameters described above for the UHR Link Reconfiguration Request frame 300. The current AP MLD then transmits a UHR Link Reconfiguration Notify frame in response using the same Type value, carrying the same parameters as described above for the UHR Link Reconfiguration Response frame 400. In yet another alternative embodiment, the non-AP MLD sends a UHR Link Reconfiguration Request frame 300, and the AP MLD responds with a UHR Link Reconfiguration Notify frame carrying the response parameters. In all such embodiments, the exchanged frames can be PMF protected, and the Basic ML element in the AP MLD's response provides the same UHR-specific BSS parameters for the requested links, as described above.

In another embodiment, dedicated BSS Capabilities and Operation Parameters Request and Response action frames, distinct from the UHR Link Reconfiguration frame type, may be defined for the same purpose of securely providing the latest UHR parameters to requesting STAs. These new action frames are designed to carry the same set of information as ML Probe Request and Response frames. When sent individually addressed, these frames are PMF protected. When the response frame is sent broadcast addressed, the AP MLD may send it integrity protected by including a MIC generated using the IGTK, BIGTK, or another key, or may instead send it encrypted using the IGTK or another group key derived for this purpose, enabling multiple STAs to receive the same updated parameters in a single broadcast transmission without requiring individual unicast exchanges. The AP MLD determines whether to send the response frame individually addressed or broadcast addressed at its discretion, based on factors such as the number of requesting STAs, network conditions, or the applicability of the updated parameters to multiple associated STAs.

In another embodiment, IEEE 802.11bi-defined PMF protected EPP Capabilities And Operation Parameters Request and Response action frames may be extended to carry UHR-defined elements and used by a UHR non-AP MLD to retrieve the latest updated UHR parameters from its current UHR AP MLD. The non-AP MLD sends the EPP Capabilities And Operation Parameters Request frame as a PMF-protected frame, and the current AP MLD responds with a PMF-protected EPP Capabilities And Operation Parameters Response frame. The response frame includes a Basic ML element providing the latest BSS parameters (e.g., including UHR Capabilities, UHR Operation, UHR Parameters Update elements, SMD information, UHR Security Information, etc.) for one or more requested affiliated APs. As with the UHR Link Reconfiguration-based request frames, the non-AP MLD may limit the request to a subset of affiliated APs or links by including corresponding Per-STA Profile subelements in a Basic ML element (or another ML element) in the request frame, restricted to the links for which the non-AP MLD has detected a BSS parameters critical update based on the Critical Update Counter and/or UHR BPCC. The non-AP MLD may further narrow the scope of the response by including a Request element and/or Extended Request element in the Per-STA Profile subelements to specify particular UHR-defined elements, such as a UHR Parameters Update element or a UHR Operation element, rather than all BSS parameters. The current AP MLD may also transmit an EPP Capabilities And Operation Parameters Response frame unsolicited (e.g., without receiving a prior request) to proactively push updated BSS parameters to associated non-AP MLDs. The unsolicited response frame may be individually addressed, such as to specific non-AP MLDs that have the link with updated parameters among their setup links, or broadcast addressed to simultaneously deliver updated parameters to multiple associated STAs. When broadcast addressed, the EPP Capabilities And Operation Parameters Response frame may be integrity protected using IGTK and BPE.

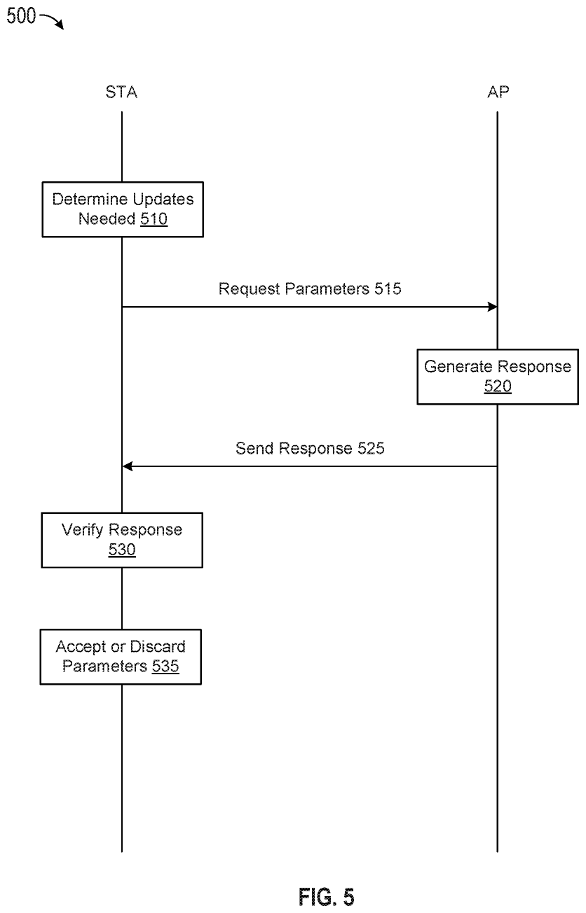

FIG. 5 illustrates a signaling flow 500 for exchanging protected request and response frames to deliver updated UHR parameters. The signaling flow 500 is between a STA and an AP.

At stage 510, the STA determines that it needs to retrieve updated UHR operating mode parameters from the AP. This occurs when the STA was in deep sleep during the entirety of the notification period for a critical update, both before and after the critical update became effective, and therefore did not receive the updated parameters in Beacon frames or other management frames during that period. The STA may detect this situation upon waking by observing a changed UHR BPCC or Critical Update Counter value for one or more links of the AP MLD.

Prior to generating a request at stage 515, the STA can determine whether the AP supports integrity protection of broadcast addressed Probe Response frames by checking for a “Broadcast Probe Response Protection” capability field (or another field) advertised by the AP in Beacon frames, Probe Response frames, or other management frames. A MIB variable dot11ProbeResponseProtectionEnabled may be defined for this capability and set to true when the capability is supported. This capability field may be located in the RSNXE element or RSNE element, the Extended Capabilities element, a UHR Security Information element, a Security Profile element, or the UHR Capabilities element or another existing or new element. For an AP MLD, all affiliated APs must indicate this capability consistently. Within a SMD, all AP MLDs of the SMD must maintain consistent capability signaling to ensure seamless roaming and link switching. The STA should send a protected Probe Request frame to the AP only when this capability is indicated by the AP.

At stage 515, the STA generates and sends a request frame to the AP to solicit the updated parameters. In a first embodiment, the STA sends a PMF-protected Probe Request frame (encrypted with the PTK), which may be a non-ML Probe Request or an ML Probe Request, to its associated AP MLD. If the Probe Request and Probe Response are not sent as encrypted frames, both may instead be integrity protected by adding a MIC as the last element before the FCS, with the MIC for the Probe Request generated using the PTK, IGTK, PIGTK, BIGTK, or another key established for this purpose. In some embodiments, the Probe Request frame is sent unprotected as defined in 802.11 baseline. In a second embodiment, the STA sends a UHR Link Reconfiguration Request frame 300 with the Type field 305 set to the new Type value as described with respect to FIG. 3. In a third embodiment, the STA sends an EPP Capabilities And Operation Parameters Request frame PMF protected to the current AP MLD. In all embodiments, the request frame may indicate the specific subset of links for which updated parameters are needed, identified using Per-STA Profile subelements, each specifying a Link ID as defined in the 802.11 baseline, in the ML element included in the request frame, and may further include a Request element and/or Extended Request element in those Per-STA Profile subelements specifying particular UHR-defined elements being requested.

At stage 520, the AP generates a response frame providing the updated parameters. In the Probe Response embodiment, the AP MLD generates a Probe Response frame including a Basic ML element containing the latest UHR operational parameters and other BSS and MLD parameters. If the response is broadcast addressed and integrity protected, the AP MLD generates a MIC over the frame body using BIP and the designated integrity key (e.g., the BIGTK, IGTK, PIGTK, or BPE-IGTK) as applicable, and appends the MME 210 as the last element of the frame body immediately before the FCS, as described with respect to FIG. 2. If the broadcast addressed Probe Response is instead sent encrypted, the AP MLD uses the IGTK or another group key derived for this purpose for encrypting the frame. If the response is individually addressed and the non-encrypted integrity-only embodiment is used, the AP MLD generates the MIC for the Probe Response using the PTK or another established pairwise key and appends it as the last element before the FCS. In the UHR Link Reconfiguration embodiment, the AP generates a UHR Link Reconfiguration Response frame 400 or a UHR Link Reconfiguration Notify frame as described with respect to FIG. 4, PMF protected. In the EPP embodiment, the AP generates a PMF-protected EPP Capabilities And Operation Parameters Response frame. In all embodiments, the response frame carries the latest UHR-specific BSS parameters for the requested links in a Basic ML element (or another ML element) with Per-STA Profile subelements as described above. The AP MLD determines at its discretion whether to transmit the response frame individually addressed or broadcast addressed, based on factors such as the number of requesting STAs, network conditions, or the applicability of the updated parameters to multiple associated STAs. Additionally, the AP MLD may generate and transmit a response frame unsolicited, either individually addressed to specific non-AP MLDs or broadcast addressed, to proactively push updated parameters to associated STAs without waiting for a request.

At stage 525, the AP transmits the response frame to the STA. The AP MLD determines whether to send the response individually addressed or broadcast addressed at its discretion. If the response is individually addressed and PMF-protected, it is transmitted encrypted using the pairwise key established between the AP and the STA. If the response is individually addressed in the non-encrypted integrity-only embodiment, it is integrity protected using a MIC generated with the PTK and MME including the MIC appended as the last element before the FCS. If the response is broadcast addressed, it is either integrity protected using BIP and the designated integrity key (e.g., the BIGTK, IGTK, PIGTK, or BPE-IGTK) as applicable with the MME 210 appended as the last element before the FCS, or encrypted using the IGTK or another derived group key.

At stage 530, the STA verifies the received response frame. In the broadcast addressed Probe Response embodiment, the requesting STA (and any non-AP MLD passively listening on the channel) detects the “Broadcast Probe Response Protection” capability advertised by the AP and looks for an MME as the last element in the received broadcast addressed Probe Response frame. The STA extracts the MME and verifies the MIC using the corresponding integrity key (BIGTK, IGTK, or PIGTK, as applicable and as defined by the applicable amendment) and the group management cipher defined in the RSNE or another security element. For individually addressed PMF-protected response frames, such as the UHR Link Reconfiguration Response frame 400 or an EPP Capabilities And Operation Parameters Response frame, the STA performs standard PMF decryption and integrity verification using the PTK.

At stage 535, the STA accepts or discards the received UHR operation parameters based on the outcome of verification at stage 530. If verification is successful, the STA accepts the updated parameters, updates its record of UHR operational and BSS and MLD-level parameters, and operates according to the updated configuration. If verification fails, the STA discards the frame to prevent injection of false operational parameters. Non-AP MLDs that did not send a Probe Request but were passively listening on the channel may independently receive a broadcast addressed Probe Response frame, perform MIC verification, and, upon successful verification, accept the updated UHR operating parameters and other BSS and MLD-level information without sending an individual Probe Request or another request frame to request for updated parameters. This passive consumption of broadcast integrity-protected Probe Response frames significantly reduces the total number of unicast Probe Request/Response exchanges (or other request/response exchanges) needed in the BSS for the STA to retrieve updated parameters, minimizing airtime overhead while maintaining the security guarantees provided by integrity protection.

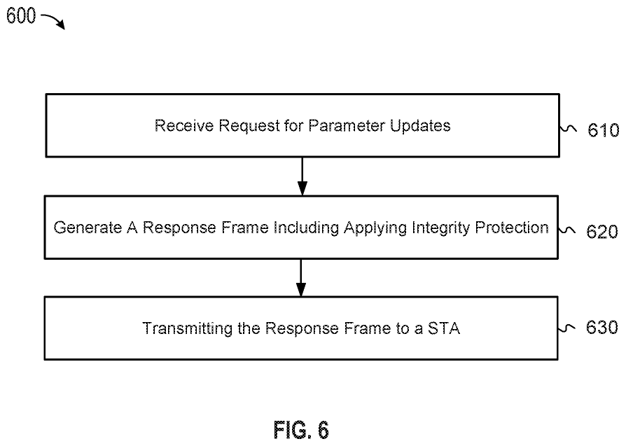

FIG. 6 illustrates a method 600 for providing protection of request frames and response frames for communicating parameter updates. The method 600 may be performed by an AP, such as the AP MLD 102 of FIG. 1, in connection with delivering UHR operating parameters to an associated STA following a critical update.

At stage 610, the AP receives a request frame from the STA requesting UHR operating parameters (e.g., UHR BSS and/or MLD operating parameters) for one or more links of the AP. The request frame can be protected according to the mechanisms described above.

At stage 620, the AP generates a response frame comprising the UHR operating parameters for the one or more links of the AP, wherein generating the response frame comprises applying integrity protection to the response frame. The UHR operating parameters are associated with a critical update to one or more UHR operating modes or operating mode parameters of the AP.

In some embodiments, the response frame is a broadcast addressed Probe Response frame, and applying the integrity protection comprises appending an MME as a last element in a frame body of the response frame, the MME comprising a MIC generated over the frame body using a BIP and an integrity key. The integrity key is any one of a BIGTK, an IGTK, a PIGTK, or a BPE-IGTK. In some embodiments, the integrity key is a PIGTK, and the AP distributes the PIGTK to one or more associated STAs via at least one of a 4-way handshake, a group key handshake, or another group key delivery mechanism. In some embodiments, the response frame is individually addressed to the STA, and applying the integrity protection comprises encrypting the response frame using a pairwise key established between the AP and the STA. In some embodiments, the response frame is individually addressed in a non-encrypted integrity-only mode and applying the integrity protection comprises appending a MIC generated using a PTK as a last element before an FCS of the response frame.

In some embodiments, the response frame is any one of a UHR Link Reconfiguration Response frame, a UHR Link Reconfiguration Notify frame, or an EPP Capabilities and Operation Parameters Response frame, and applying the integrity protection comprises transmitting the response frame as a PMF. In some embodiments, the response frame comprises a Basic ML element comprising one or more Per-STA Profile subelements, each Per-STA Profile subelement identifying a Link ID of a corresponding link of the one or more links and carrying one or more UHR-defined elements for that link, including any one of a UHR Capabilities element, a UHR Operation element, an SMD Information element, or a UHR Parameters Update element. In some embodiments, the AP determines whether to transmit the response frame individually addressed or broadcast addressed at its discretion, based on factors such as the number of requesting STAs, network conditions, or the applicability of the updated parameters to multiple associated STAs.

At stage 630, the AP transmits the response frame to the STA. In some embodiments, the AP transmits the response frame after receiving a request frame from the STA requesting the UHR operating parameters for the one or more links of the AP. The request frame may be any one of an encrypted Probe Request frame or a Probe Request frame integrity protected by a MIC. In other embodiments, the AP transmits the response frame unsolicited (without having received a prior request from the STA) and the response frame may be individually addressed to one or more specific STAs or broadcast addressed to a plurality of associated STAs.

In some embodiments, the method 600 further comprises signaling support for integrity protection of response frames to the STA in any one of a RSNXE element, an Extended Capabilities element, a UHR Security Information element, a Security Profile element, or a UHR Capabilities element of one or more management frames. In some embodiments, all affiliated APs of the AP MLD consistently indicate the same value for this capability, and all AP MLDs within a SMD maintain consistent capability signaling to support seamless roaming and link switching.

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for providing integrity protection for requests and responses for communicating updates. Computing device 700, for example, may provide an operating environment for the AP MLD 102, the controller 104, the non-AP MLDs 110, the devices of the network 120, and the like. The AP MLD 102, the controller 104, the non-AP MLDs 110, the devices of the network 120, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 700 on the single integrated circuit (chip).

FIG. 8 illustrates an implementation of a communications device 800 that may implement one or more of the AP MLD 102, the controller 104, the non-AP MLDs 110, the devices of the network 120, etc. In various implementations, the communications device 800 may comprise a logic circuit. The logic circuit may include physical circuits to perform operations described for one or more of the AP MLD 102, the controller 104, the non-AP MLDs 110, the devices of the network 120, etc., for example. As shown in FIG. 8, the communications device 800 may include one or more of, but is not limited to, a radio interface 810, baseband circuitry 830, and/or the computing device 700.

The communications device 800 may implement some or all of the structures and/or operations for the AP MLD 102, the controller 104, the non-AP MLDs 110, the devices of the network 120, etc., storage medium, and logic circuit in a single computing entity, such as entirely within a single device. Alternatively, the communications device 800 may distribute portions of the structure and/or operations using a distributed system architecture, such as a client station server architecture, a peer-to-peer architecture, a master-slave architecture, etc.

A radio interface 810, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 810 may include, for example, a receiver 815 and/or a transmitter 820. The radio interface 810 may include bias controls, a crystal oscillator, and/or one or more antennas 825. In additional or alternative configurations, the radio interface 810 may use oscillators and/or one or more filters, as desired.

The baseband circuitry 830 may communicate with the radio interface 810 to process, receive, and/or transmit signals and may include, for example, an Analog-To-Digital Converter (ADC) for down converting received signals with a Digital-To-Analog Converter (DAC) 835 for up converting signals for transmission. Further, the baseband circuitry 830 may include a baseband or PHY layer processing circuit for the PHY link layer processing of respective receive/transmit signals. Baseband circuitry 830 may include, for example, a MAC processing circuit 840 for MAC/data link layer processing. Baseband circuitry 830 may include a memory controller for communicating with MAC processing circuit 840 and/or a computing device 700, for example, via one or more interfaces 845.

In some configurations, PHY processing circuit may include a frame construction and/or detection module, in combination with additional circuitry such as a buffer memory, to construct and/or deconstruct communication frames. Alternatively or in addition, MAC processing circuit 840 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
receiving, by an access point (AP), a request frame from a station (STA) requesting Ultra High Reliability (UHR) operating parameters for one or more links of the AP;
generating, by the AP, a response frame comprising the UHR operating parameters for the one or more links of the AP, wherein generating the response frame comprises applying integrity protection to the response frame; and
transmitting, by the AP, the response frame to the STA.

2. The method of claim 1, wherein:
the request frame is a protected management frames (PMF) encrypted enhanced privacy protection (EPP) capabilities and operation parameters request frame; and
the response frame is PMF encrypted EPP capabilities and operation parameters response frame.

3. The method of claim 1, wherein the request frame is any one of: an encrypted probe request frame, a probe request frame integrity protected by a message integrity code (MIC), or an unprotected request frame.

4. The method of claim 1, wherein:
the response frame is a broadcast addressed probe response frame; and
applying the integrity protection comprises appending a management MIC element (MME) as a last element in a frame body of the response frame, the MME comprising a MIC generated over the frame body using a broadcast/multicast integrity protocol (BIP) and an integrity key.

5. The method of claim 4, wherein the integrity key is any one of: a beacon integrity group temporal key (BIGTK), an integrity group temporal key (IGBTK), a probe response integrity group temporal key (PIGTK), a basic service set (BSS) privacy enhancement integrity key (BPE-IGTK).

6. The method of claim 1, wherein:
the response frame is individually addressed to the STA; and
applying the integrity protection comprises encrypting the response frame.

7. The method of claim 1, further comprising:
signaling integrity protection support to the STA in any one of: a robust security network (RSN) element, an RSN extension element, an extended capabilities element, a UHR security information element, a security profile element, or a UHR capabilities element of one or more frames.

8. The method of claim 1, wherein the response frame is any one of a UHR Link Reconfiguration Response frame or a UHR Link Reconfiguration Notify frame.

9. The method of claim 1, wherein the response frame comprises a basic multi-link (ML) element comprising one or more per-STA profile subelements, each per-STA profile subelement identifying a link identifier and UHR operating parameters of a corresponding link of the one or more links.

10. A system comprising:
a memory storage; and
a processing unit coupled to the memory storage, wherein the processing unit is operative to:
receive a request frame from a station (STA) requesting Ultra High Reliability (UHR) operating parameters for one or more links.
generate a response frame comprising the UHR operating parameters for the one or more links, wherein generating the response frame comprises applying integrity protection to the response frame; and
transmit the response frame to the STA.

11. The system of claim 10, wherein the processing unit is further operative to, prior to generating the response frame, receive a request frame from the STA requesting the UHR operating parameters for the one or more links, wherein the request frame is any one of: an encrypted probe request frame, a probe request frame integrity protected by a message integrity code (MIC).

12. The system of claim 10, wherein applying the integrity protection comprises to append a management MIC element (MME) as a last element in a frame body of the response frame, the MME comprising a MIC generated over the frame body using a broadcast/multicast integrity protocol (BIP) and an integrity key, wherein the integrity key is any one of: a beacon integrity group temporal key (BIGTK), an integrity group temporal key (IGBTK), a probe response integrity group temporal key (PIGTK), a BSS privacy enhancement integrity key (BPE-IGTK).

13. The system of claim 10, wherein the processing unit is further operative to signal integrity protection support to the STA in any one of: a robust security network (RSN) element, an RSN extension element, an extended capabilities element, a UHR security information element, a security profile element, or a UHR capabilities element of one or more frames.

14. The system of claim 10, wherein the response frame is any one of a UHR Link Reconfiguration Response frame or a UHR Link Reconfiguration Notify frame.

15. A non-transitory computer-readable medium that stores a set of instructions which when executed by a processing unit, cause the processing unit to perform a method comprising:
receiving a request frame from a station (STA) requesting Ultra High Reliability (UHR) operating parameters for one or more links;
generating a response frame comprising the UHR operating parameters for the one or more links, wherein generating the response frame comprises applying integrity protection to the response frame; and
transmitting the response frame to the STA.

16. The non-transitory computer-readable medium of claim 15, the method executed by the set of instructions further comprising:
prior to generating the response frame, receiving a request frame from the STA requesting the UHR operating parameters for the one or more links, wherein the request frame is any one of: an encrypted probe request frame, a probe request frame integrity protected by a message integrity code (MIC).

17. The non-transitory computer-readable medium of claim 15, wherein applying the integrity protection comprises appending a management MIC element (MME) as a last element in a frame body of the response frame, the MME comprising a MIC generated over the frame body using a broadcast/multicast integrity protocol (BIP) and an integrity key, wherein the integrity key is any one of: a beacon integrity group temporal key (BIGTK), an integrity group temporal key (IGBTK), a probe response integrity group temporal key (PIGTK), a BSS privacy enhancement integrity key (BPE-IGTK).

18. The non-transitory computer-readable medium of claim 15, the method executed by the set of instructions further comprising:
signaling integrity protection support to the STA in any one of: a robust security network (RSN) element, an RSN extension element, an extended capabilities element, a UHR security information element, a security profile element, or a UHR capabilities element of one or more frames.

19. The non-transitory computer-readable medium of claim 15, wherein:
the response frame is individually addressed to the STA; and
applying the integrity protection comprises encrypting the response frame.

20. The non-transitory computer-readable medium of claim 15, wherein the response frame comprises a basic multi-link (ML) element comprising one or more per-STA profile subelements, each per-STA profile subelement identifying a link identifier and UHR operating parameters of a corresponding link of the one or more links.
